(19) United States
(12) Patent Application Publication
(10) Pub. No.: US 2018/0095605 A1
(43) Pub. Date: Apr. 5, 2018

(54) Generating a Mixed reality Interface to Expose Object Functionality

(71) Applicant: International Business Machines Corporation, Armonk, NY (US)

(72) Inventors: Romelia H. Flores, Keller, TX (US); Christian E. Loza, Denton, TX (US); Olivia G. Loza, Denton, TX (US); Tomyo G. Maeshiro, Denton, TX (US)

(21) Appl. No.: 15/283,060

(22) Filed: Sep. 30, 2016

(51) Int. Cl. G06F 3/0482

(52) U.S. Cl. CPC G06F 3/0482; H04L 67/12

(57) ABSTRACT

Invoking a function of a mixed reality interaction enabled object is provided. In response to determining that an input was received selecting the mixed reality interaction enabled object to perform an action, an interface is received showing a set of available application programming interfaces and functions corresponding to the mixed reality interaction enabled object. A selection of one of the set of available application programming interfaces and functions corresponding to the mixed reality interaction enabled object is received via the interface. The action corresponding to the selection of the one of the set of available application programming interfaces and functions is invoked on the mixed reality interaction enabled object.

### BACKGROUND

### 1. Field

The disclosure relates generally to mixed reality environments and more specifically to generating an interface in a mixed reality environment that exposes functionality of an object in the mixed reality environment and invoking a function of the object via the interface.

### 2. Description of the Related Art

Mixed reality combines both virtual reality and reality objects. Mixed reality is also known as hybrid reality because it embraces the merging of real and virtual worlds to produce new environments and visualizations where physical and digital objects co-exist and interact in real time. Mixed reality takes place not only in the physical world or the virtual world, but is a mixture of reality and virtual reality, encompassing both augmented reality and augmented virtuality. A virtual environment is one in which a participant is immersed in and able to interact with a synthetic or virtual world. Head-mounted displays or headsets that provide the ability to immerse participants in a virtual reality environment are available today. Currently, a mixed reality headset would place virtual objects in the real world and allow users to interact with them through gestures and voice commands.

### SUMMARY

According to one illustrative embodiment, a computer-implemented method for invoking a function of a mixed reality interaction enabled object is provided. In response to a data processing system determining that an input was received selecting a mixed reality interaction enabled object to perform an action, the data processing system receives an interface showing a set of available application programming interfaces and functions corresponding to the mixed reality interaction enabled object. The data processing system receives a selection of one of the set of available application programming interfaces and functions corresponding to the mixed reality interaction enabled object via the interface. The data processing system invokes the action on the mixed reality interaction enabled object corresponding to the selection of the one of the set of available application programming interfaces and functions. According to other illustrative embodiments, a data processing system and computer program product for invoking a function of a mixed reality interaction enabled object are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of mixed reality system in accordance with an illustrative embodiment;

FIG. 4 is a diagram illustrating an example of a mixed reality environment in accordance with an illustrative embodiment;

FIG. 5 is an example of multiple mixed reality interaction enabled objects with a set of shared available functions in accordance with an illustrative embodiment;

FIG. 6 is a flowchart illustrating a process for invoking a function corresponding to a mixed reality object in accordance with an illustrative embodiment; and

FIGS. 7A-7B are a flowchart illustrating a process for invoking a common function corresponding to multiple mixed reality objects in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

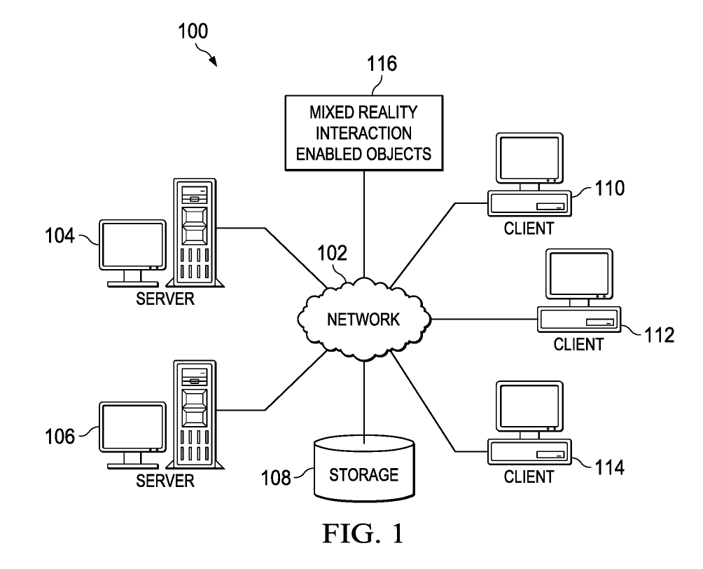

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. Server 104 and server 106 may provide a set of services to users of client devices connected to network 102. For example, server 104 and server 106 may provide a set of communication services to client device users. Further, server 104 and server 106 may provide mixed reality services to client device users. Also, it should be noted that server 104 and server 106 may represent a plurality of different servers providing a plurality of different communication and mixed reality services.

Client 110, client 112, and client 114 also connect to network 102. Clients 110, 112, and 114 are clients of server 104 and server 106. Further, server 104 and server 106 may provide information, such as boot files, operating system images, and software applications to clients 110, 112, and 114.

In this example, clients 110, 112, and 114 are illustrated as desktop or personal computers with wire or wireless communication links to network 102. However, it should be noted that clients 110, 112, and 114 are meant as examples only. In other words, clients 110, 112, and 114 may include other types of data processing systems, such as, for example, head-mounted display devices, head-up display devices, holographic display devices, laptop computers, handheld computers, smart phones, cellular phones, smart watches, personal digital assistants, gaming devices, kiosks, set top boxes, and the like. Clients 110, 112, and 114 are mixed reality interface devices. Users of clients 110, 112, and 114 may utilize clients 110, 112, and 114 to interface and interact with mixed reality interaction enabled objects 116. In addition, users of clients 110, 112, and 114 may utilize clients 110, 112, and 114 to access the communication and mixed reality services provided by server 104 and server 106.

Mixed reality interaction enabled objects 116 also connect to network 102. Mixed reality interaction enabled objects 116 represent a plurality of different objects that are enabled for interaction within a mixed reality environment by users of clients 110, 112, and 114. Mixed reality interaction enabled objects 116 may include, for example, electronic devices, such as landline telephones, televisions, refrigerators, thermostats, stereos, speakers, light switches, computers, clocks, and the like, with a plurality of different functionality. Mixed reality interaction enabled objects 116 also may include other types of inanimate objects, such as, food, furniture, equipment, books, and the like. Mixed reality interaction enabled objects 116 present an interface, which displays available functions and application programming interfaces corresponding to respective mixed reality interaction enabled objects, to clients 110, 112, and 114 when clients 110, 112, and 114 are within a predetermined distance from an object in mixed reality interaction enabled objects 116 and a user focuses a client device corresponding to the user on the object. The user of the client device may then select one or more of the available functions or application programming interfaces listed in the interface and thereby invoke performance of a selected function or application programming interface corresponding to that object. Thus, a client device user may control functionality corresponding to a particular mixed reality interaction enabled object within a mixed reality environment, via a displayed interface on the client device, without physically interacting with that particular mixed reality interaction enabled object.

Storage 108 is a network storage device capable of storing any type of data in a structured format or an unstructured format. In addition, storage 108 may represent a set of one or more network storage devices. Storage 108 may store, for example, names and identification information for a plurality of different users; identification of a plurality of different client devices corresponding to the users; identification of a plurality of different mixed reality interaction enabled objects along with corresponding functionality; user profiles corresponding to each of the users; mixed reality interaction enabled object profiles corresponding to each of the plurality of different mixed reality interaction enabled objects; and the like. Further, storage 108 also may store other data, such as authentication or credential data that may include user names, passwords, and biometric data associated with the plurality of different users, for example.

In addition, it should be noted that network data processing system 100 may include any number of additional server devices, client devices, mixed reality interaction enabled objects, and other devices not shown. Program code located in network data processing system 100 may be stored on a computer readable storage medium and downloaded to a computer or data processing system for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a personal area network (PAN), or any combination thereof. FIG. 1 is intended as an example, and not as an architectural limitation for the different illustrative embodiments.

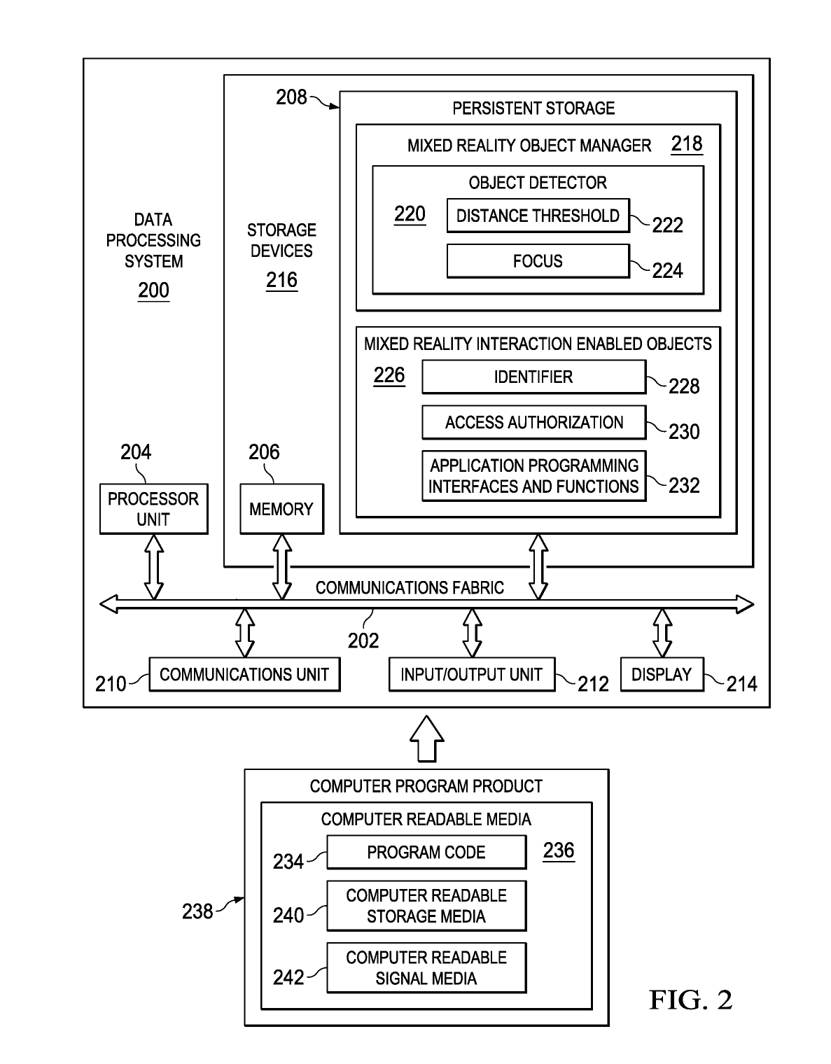

With reference now to FIG. 2, a diagram of a data processing system is depicted in accordance with an illustrative embodiment. Data processing system 200 is an example of a mixed reality interface device, such as client 110 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores mixed reality object manager 218. Mixed reality object manager 218 controls functionality corresponding to mixed reality interaction enabled objects, such as, for example, mixed reality interaction enabled objects 116 in FIG. 1, within a mixed reality environment. Mixed reality object manager 218 receives and displays on display 214 an interface, which is generated by the mixed reality interaction enabled objects, that lists the different available functions for interaction by a user of data processing system 200. The user of data processing system 200 may select a function, such as, for example, a power on function, corresponding to a particular mixed reality interaction enabled object via the displayed interface. Selection of a function in the displayed interface by the user invokes performance of that function, such as, for example, powering on that particular mixed reality interaction enabled object, without the user physically interacting with that particular mixed reality interaction enabled object in the real world.

It should be noted that even though mixed reality object manager 218 is illustrated as residing in persistent storage 208, in an alternative illustrative embodiment mixed reality object manager 218 may be a separate component of data processing system 200. For example, mixed reality object manager 218 may be a hardware component coupled to communication fabric 202 or a combination of hardware and software components. In another alternative illustrative embodiment, mixed reality object manager 218 may be located in a mixed reality server, such as server 104 in FIG. 1. In yet another alternative illustrative embodiment, a first portion of the components of mixed reality object manager 218 may be located in data processing system 200 and a second portion of the components may be located in a mixed reality server.

In this example, mixed reality object manager 218 includes object detector 220. Mixed reality object manager 218 utilizes object detector 220 to detect the mixed reality interaction enabled objects within the mixed reality environment. Object detector 220 may utilize distance threshold 222 and/or focus 224 while detecting the mixed reality interaction enabled objects. Distance threshold 222 represents a defined distance from data processing system 200 where mixed reality interaction enabled objects may be detected. In other words, mixed reality interaction enabled objects outside of distance threshold 222 are not discoverable by object detector 220. Focus 224 represents a focal point or center of attention of data processing system 200. For example, a user of data processing system 200 may focus an imaging device, such as a camera, located in data processing system 200 on a particular mixed reality interaction enabled object within the mixed reality environment. In other words, object detector may utilize focus 224 to select that particular mixed reality interaction enabled object within the mixed reality environment when that particular mixed reality interaction enabled object is within distance threshold 222.

Mixed reality interaction enabled objects 226 represent a list of detected mixed reality interaction enabled objects within distance threshold 222 that is generated by object detector 220. A mixed reality interaction enabled object of mixed reality interaction enabled objects 226 that is in focus 224 may send identifier 228, access authorization 230, and application programming interfaces and functions 232 to data processing system 200. Identifier 228 uniquely identifies the mixed reality interaction enabled object in focus 224. Access authorization 230 represents information regarding whether a particular user or a particular data processing system has authorization or not to access the mixed reality interaction enabled object in focus 224. Application programming interfaces and functions 232 represent a list of one or more available application programming interfaces and/or functions corresponding to the mixed reality interaction enabled object in focus 224. A user may select an available application programming interface or function in the list for performance by the mixed reality interaction enabled object in focus 224 or for performance in association with the mixed reality interaction enabled object in focus 224.

Communications unit 210, in this example, provides for communication with other computers, data processing systems, and mixed reality devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (WiFi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a game controller, hand gesture detector, keypad, keyboard, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 234 is located in a functional form on computer readable media 236 that is selectively removable and may be loaded onto or transferred to data processing system 200 for running by processor unit 204. Program code 234 and computer readable media 236 form computer program product 238. In one example, computer readable media 236 may be computer readable storage media 240 or computer readable signal media 242. Computer readable storage media 240 may include, for example, an optical or magnetic disc that is inserted or placed into a drive or other device that is part of persistent storage 208 for transfer onto a storage device, such as a hard drive, that is part of persistent storage 208. Computer readable storage media 240 also may take the form of a persistent storage, such as a hard drive, a thumb drive, or a flash memory that is connected to data processing system 200. In some instances, computer readable storage media 240 may not be removable from data processing system 200.

Alternatively, program code 234 may be transferred to data processing system 200 using computer readable signal media 242. Computer readable signal media 242 may be, for example, a propagated data signal containing program code 234. For example, computer readable signal media 242 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 234 may be downloaded over a network to persistent storage 208 from another device or data processing system through computer readable signal media 242 for use within data processing system 200. For instance, program code stored in a computer readable storage media in a data processing system may be downloaded over a network from the data processing system to data processing system 200. The data processing system providing program code 234 may be a server computer, a client computer, or some other device capable of storing and transmitting program code 234.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 240 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Currently, a user from the real world is able to manipulate objects that exist in a virtual world. For example, user gestures and movements have been leveraged to manipulate objects in the virtual environment. Recently there has been a lot of attention on how to further “blend” the real and virtual worlds. The emphasis has been on how to take objects from the real world and have them appear in a mixed reality environment. In some cases, video and image technology is being utilized to ensure that real world objects are given a cartoon like existence in the virtual reality world. Another example is leveraging “sensor” technology to give the mixed reality user a sense of smell or touch to provide a close to “reality” experience.

Typically, a mixed reality user is confined to manifesting objects, such as people or furniture, from the room the user is in. However, what has yet to be explored is an ability to not only manifest real world objects in the mixed reality environment, but to manipulate “functions” provided by those objects through user gestures and movements from any user in the mixed reality environment. Enabling the user to identify which real world objects they want manifested in the mixed reality environment and which they do not has not been explored. Illustrative embodiments provide an ability to connect objects identified by the user from anywhere in the real-world in the mixed reality environment. In other words, illustrative embodiments provide users a new level of accessibility to devices and functions available nearby or remotely using a mixed reality system as a framework.

The prior art does not discuss how mixed reality users can manipulate real world functions provided by objects in the mixed reality environment. In addition, the prior art does not provide a framework for enabling the mixed reality users to identify functions provided by those objects and enabling manipulation of identified functions provided by those objects from within the mixed reality environment.

Illustrative embodiments provide a framework where mixed reality objects present users with a set of functionality available to the users when the users interact with the objects. For example, a typical landline phone includes functionality to place calls, review voice mail, and receive messages. These functions are isolated and the only currently available way to access these functions is to physically interact with the phone.

Mixed reality opens the door to simplify this interaction between the user and the landline phone object. Illustrative embodiments provide a visual cue over the landline phone object in a mixed reality interface. This visual cue may be, for example, a colored dot over the object or illumination of the object to indicate that the object is a mixed reality interaction enabled object within the mixed reality environment. However, it should be noted that the visual cue may be any type of visual indicator. Illustrative embodiments make this visual cue available when the user focuses the user's direct attention on the mixed reality interaction enabled object or the user is in close proximity to the mixed reality interaction enabled object.

Illustrative embodiments will not immediately display the mixed reality interface corresponding to the object receiving user focus. Illustrative embodiments may require that the user take an additional action in order for illustrative embodiments to display the mixed reality interface. Once the user has signaled by, for example, making a hand gesture, illustrative embodiments display a contextual menu or pop up in the mixed reality interface showing the functionality corresponding to that object.

Thus, illustrative embodiments change how a user operates the functionality of a mixed reality object without physically interacting with the object, which is only possible within a mixed reality environment. Illustrative embodiments enable mixed reality objects to make their functionality known and available in a mixed reality environment, which provides an additional level of control over the mixed reality objects by the users. Further, illustrative embodiments allow users to share functionality of mixed reality interaction enabled objects with other remote users.

Illustrative embodiments provide a framework that determines when a user is in proximity (e.g., within a defined distance threshold) to one or more mixed reality objects, which are enabled for interaction within the mixed reality environment. For example, a user steps into a room within a mixed reality environment. A mixed reality interface device (e.g., a smart phone), which corresponds to the user, starts to discover whether any mixed reality interaction enabled objects are within a defined distance threshold in the room. Illustrative embodiments may implement the discovery process using different network protocols, such as, for example, Internet of Things (IoT) protocols, which allow network communication with nearby objects. The discovery process may only require that a hand shake take place between the interaction enabled object and the mixed reality interface device after the user is in proximity of the interaction enabled object. Illustrative embodiments may implement communication between the mixed reality interface device and surrounding mixed reality interaction enable objects using different standard protocols, taking into account proximity and connectivity between the mixed reality interface device and the mixed reality interaction enable objects, once illustrative embodiments identify the device and objects.

In an alternative illustrative embodiment, the mixed reality interface device corresponding to the user may transmit and publish the mixed reality interaction enabled objects that it discovered in close proximity, so that remote users in the mixed reality environment also may be able to use the functionality of those objects. The remote mixed reality users may not have direct line of sight to a mixed reality interaction enabled object, but the remote users may select an object to manipulate its functionality. In another alternative illustrative embodiment, mixed reality users are able to publish or share the availability of mixed reality interaction enabled objects to remote users in order to, but not limited to, publish information corresponding to these objects, provide access to functionality of those objects, provide access to services corresponding to those objects via application programming interfaces, and publish availability of those object services.

After mixed reality interaction enabled objects register potential interaction with illustrative embodiments, illustrative embodiments determine whether a user is focusing attention on any of the nearby interaction enabled objects. If an object is not location aware, the object may physically signal illustrative embodiments when the object is in focus. This signaling process may be active or passive signaling. For example, the object may passively signal illustrative embodiments regarding available functionality using visual marks on the object that contain identification information corresponding to the object. The visual marks may be, for example, quick response codes, bar codes, serial numbers, schematics, machine readable labels, or any visual information that may be read by illustrative embodiments. Alternatively, the object may actively signal illustrative embodiments about available functionality using visual marks and signaling devices, such as, for example, a light emitting diode, an infrared light emitting diode, and visual marks in a monitor. The visual marks may signal unidirectional or bidirectional communication to illustrative embodiments. The information exchanged by the mixed reality interaction enabled object contains the identification of the object and also may contain a set of instructions for establishing communication, exchanging information, and exchanging credentials. This information also may contain instructions on how to interact and exchange information using any available communication channels.

If a mixed reality interaction enabled object is location aware, then illustrative embodiments may use a combination of different methods to determine the position of a mixed reality interface device relative to the object and the position of other objects relative to the object within the mixed reality environment. The object also may use visual marks as described above to confirm that the object is the focus of the user's attention. The attention focus describes the space to which the user is focusing attention (e.g., where the eyes and head of the user are directed toward).

Considering that a plurality of mixed reality interaction enabled objects may exist within a mixed reality environment, illustrative embodiments allow the user to select a set of one or more objects from the plurality of objects. If the user selects only a single object, then illustrative embodiments display available functionality of that particular object to the user. If the user selects multiple objects, then illustrative embodiments display available common functionality of the multiple objects to the user.

Alternative illustrative embodiments may include identification of objects that are not connected to the network or to illustrative embodiments. To be identified, the objects need a physical medium understandable by illustrative embodiments. For example, the objects may use radio frequency identification tags, bar codes, quick response codes, and other mechanisms to share information, such as object identifiers, with the illustrative embodiments. In addition, illustrative embodiments provide a user with an ability to add information on top of the objects. For example, a user may add an information field to an object in order to share information to other users of a mixed reality environment. For example, the user may tag an object with the name of the user to avoid losing the object or may tag a food object with an expiration date to avoid eating expired food.

Moreover, illustrative embodiments may access the information corresponding to an object and use the information in an application programming interface. For example, illustrative embodiments may interact with an application programming interface of a third party in order to take an action on an object. One action may be, for example, “Buy” the object. In that sense, the user may look at the object and buy the object using the mixed reality interface device corresponding to the user, once the function interface or menu displays the availability of that “Buy” function.

After illustrative embodiments determine that a user is focusing attention on an object within a mixed reality environment, illustrative embodiments determine whether that user has authorization to access the functionality of that object. In response to illustrative embodiments determining that the user has authorization to access the functionality of that object, illustrative embodiments display an interface prompting the user for a selection of one or more functions corresponding to that object. The user performs an action to select the object and invoke display of the function interface. The function interface may be, for example, a menu with available functions. Alternatively, the function interface may include images or videos in the case where objects are publishing information about topics like how to use the objects or any other relevant information. The user may select one of the available functions in the interface. Illustrative embodiments receive the function selection from the mixed reality interface device corresponding to the user and send a command to the object to perform the function selected by the user. The object receives the command and takes the appropriate action to perform the selected function.

Alternatively, the user may select a group of available mixed reality interaction enabled objects. In that case, illustrative embodiments receive a communication from the selected group of objects regarding their respective functions and present the user with the common functionality corresponding to the selected group of objects. For example, the objects may share the common function “Mute”. Illustrative embodiments present the user with the common function of “Mute” to mute each object in the selected group of objects within the mixed reality environment. Illustrative embodiments send the command to the selected group of objects using the communication protocol selected during the discovery phase. Mixed reality interaction enabled object profiles may include information regarding available objects and respective functions available through those objects. Mixed reality user profiles may include information regarding mixed reality interface devices corresponding to respective users in the mixed reality environment. In addition, user profiles also may include information regarding which users are authorized to access mixed reality interaction enabled devices remotely.

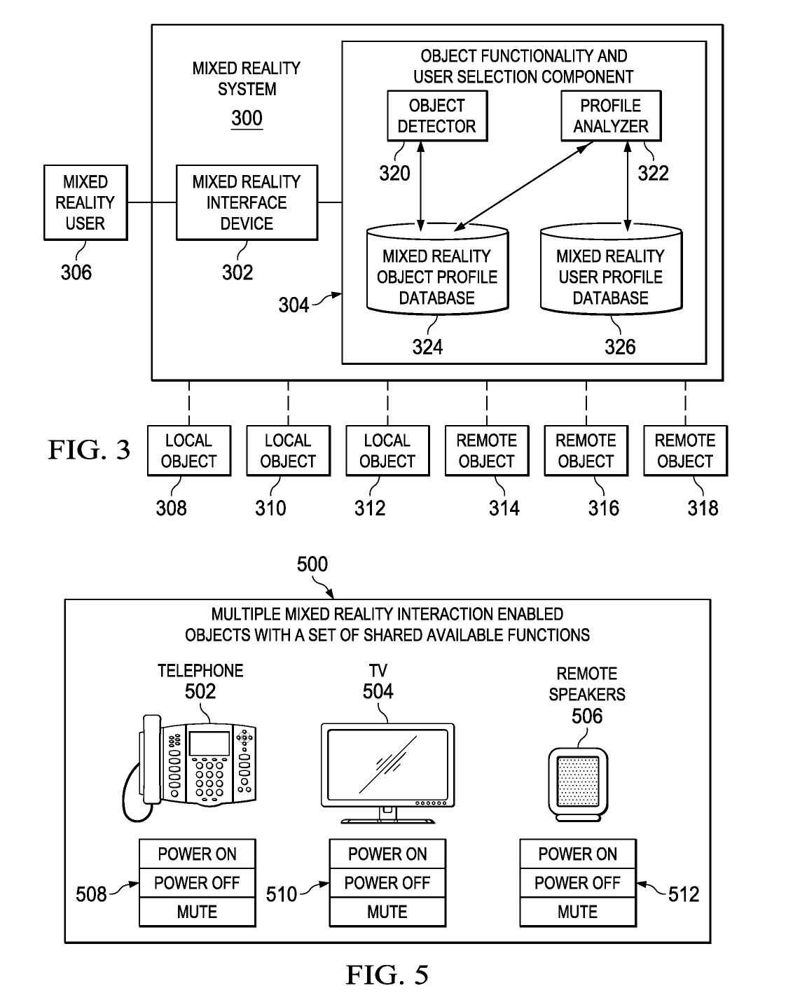

With reference now to FIG. 3, a diagram illustrating an example of mixed reality system is depicted in accordance with an illustrative embodiment. Mixed reality system 300 is a combination of hardware and software components for controlling functionality of mixed reality interaction enabled objects within a mixed reality environment. Mixed reality system 300 may be implemented in, for example, network data processing system 100 in FIG. 1.

In this example, mixed reality system 300 includes mixed reality interface device 302 and object functionality and user selection component 304. Mixed reality interface device 302 represents a hardware device and may be, for example, client 110 in FIG. 1. Mixed reality interface device 302 corresponds to mixed reality user 306. In other words, mixed reality user 306 utilizes mixed reality interface device 302 to interface and interact with mixed reality interaction enabled objects, such as mixed reality interaction enabled objects 116 in FIG. 1, which are coupled to mixed reality system 300.

In this example, local object 308, local object 310, local object 312, remote object 314, remote object 316, and remote object 318 represent a plurality of mixed reality interaction enabled objects coupled to mixed reality system 300. Local object 308, local object 310, and local object 312 represent mixed reality interaction enabled objects that mixed reality user 306 may interact with and control their respective functionality locally via mixed reality interface device 302. Remote object 314, remote object 316, and remote object 318 represent mixed reality interaction enabled objects that mixed reality user 306 may interact with and control their respective functionality remotely via connecting mixed reality interface device 302 to one or more other mixed reality interface devices, such as client 112 and/or client 114 in FIG. 1, which are locally controlling remote object 314, remote object 316, and remote object 318.

Object functionality and user selection component 304 is a software component for receiving selections made by mixed reality user 306 of functionality corresponding to mixed reality interaction enabled objects. In one illustrative embodiment, object functionality and user selection component 304 may be located in mixed reality interface device 302. In an alternative illustrative embodiment, object functionality and user selection component 304 may be located in a server device, such as server 104 in FIG. 1. In another alternative illustrative embodiment, different components of object functionality and user selection component 304 may be located in mixed reality interface device 302 and in the server device.

In this example, object functionality and user selection component 304 includes object detector 320 and profile analyzer 322. Object detector 320 may be, for example, object detector 220 in FIG. 2. Object detector 320 detects when one or more mixed reality interaction enabled objects are within a defined distance threshold, such as distance threshold 222 in FIG. 2. In addition, object detector 320 determines whether mixed reality interface device 302 is directing its focus, such as focus 224 in FIG. 2, on a mixed reality interaction enabled object, such as local object 308. Further, object detector 320 retrieves data from mixed reality object profile database 324. Mixed reality object profile database 324 may store information, such as, for example, object identifiers, object access authorizations, object functionalities, and the like, for a plurality of different mixed reality interaction enabled objects.

Profile analyzer 322 analyzes data retrieved from mixed reality object profile database 324 and mixed reality user profile database 326. Mixed reality user profile database 326 may store information, such as, for example, user identifiers, mixed reality interface device identifiers corresponding to the different users, object access authorizations corresponding to the different users, and the like, for a plurality of different mixed reality users of mixed reality system 300. Object functionality and user selection component 304 may utilize information provided by object detector 320 and profile analyzer 322 to control functionality of mixed reality interaction enabled objects selected by mixed reality user 306 and to determine whether mixed reality user 306 has authorization to access the functionality of particular objects within mixed reality system 300.

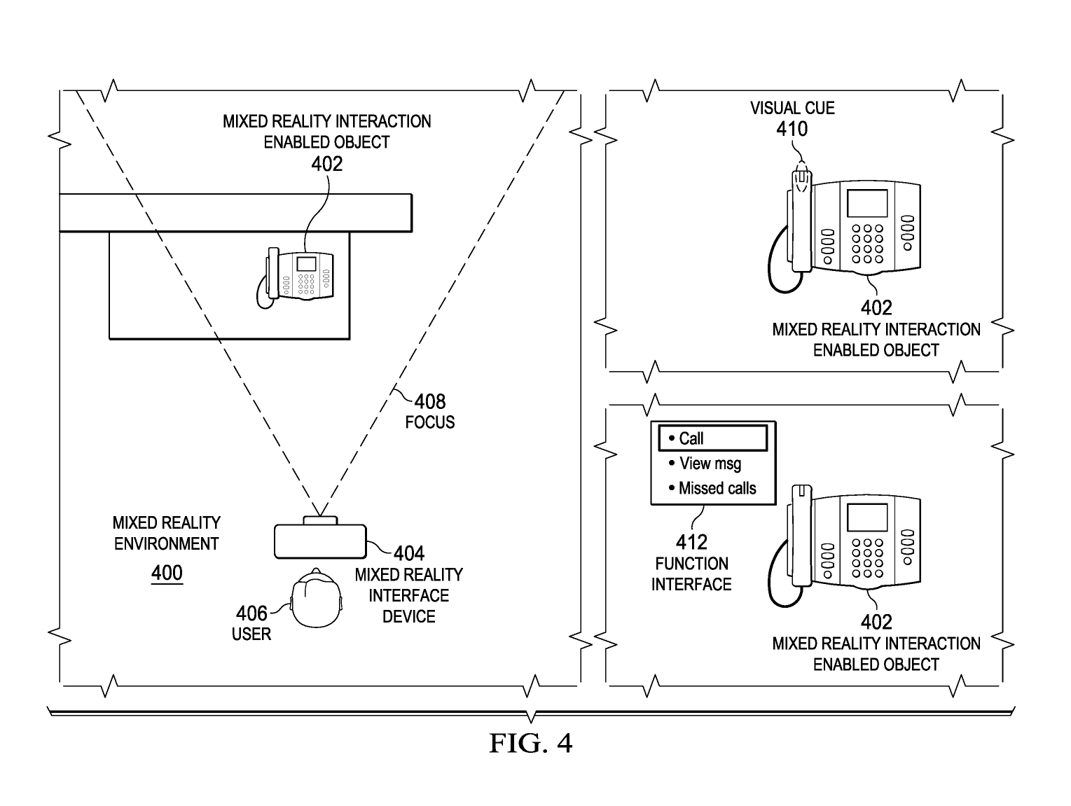

With reference now to FIG. 4, a diagram illustrating an example of a mixed reality environment is depicted in accordance with an illustrative embodiment. Mixed reality environment 400 includes mixed reality interaction enabled object 402 and mixed reality interface device 404. Mixed reality interaction enabled object 402 may be, for example, local object 308 in FIG. 3. Mixed reality interface device 404 may be, for example, mixed reality interface device 302 in FIG. 3.

In this example, mixed reality interaction enabled device 402 is a landline telephone. User 406, such as mixed reality user 306 in FIG. 3, utilizes mixed reality interface device 404 to interact with and control functionality of mixed reality interaction enabled device 402. In response to user 406 directing focus 408 of mixed reality interface device 404 on mixed reality interaction enabled device 402, mixed reality interaction enabled device 402 displays visual cue 410, which indicates to user 406 that mixed reality interaction enabled device 402 is a mixed reality interaction enabled device. In response to user 406 selecting mixed reality interaction enabled device 402 by, for example, making a specific gesture or motion, mixed reality interaction enabled device 402 displays function interface 412. Function interface 412 lists functions of mixed reality interaction enabled device 402 that are available to user 406 for selection.

In this example, function interface 412 lists functions “Call”, “View Message”, and “Missed Calls”. Also in this example, user 406 selects function “Call”. In other words, user 406 is directing mixed reality interaction enabled device 402 to place a call via mixed reality interface device 404 without physically interacting with mixed reality interaction enabled device 402 in mixed reality environment 400.

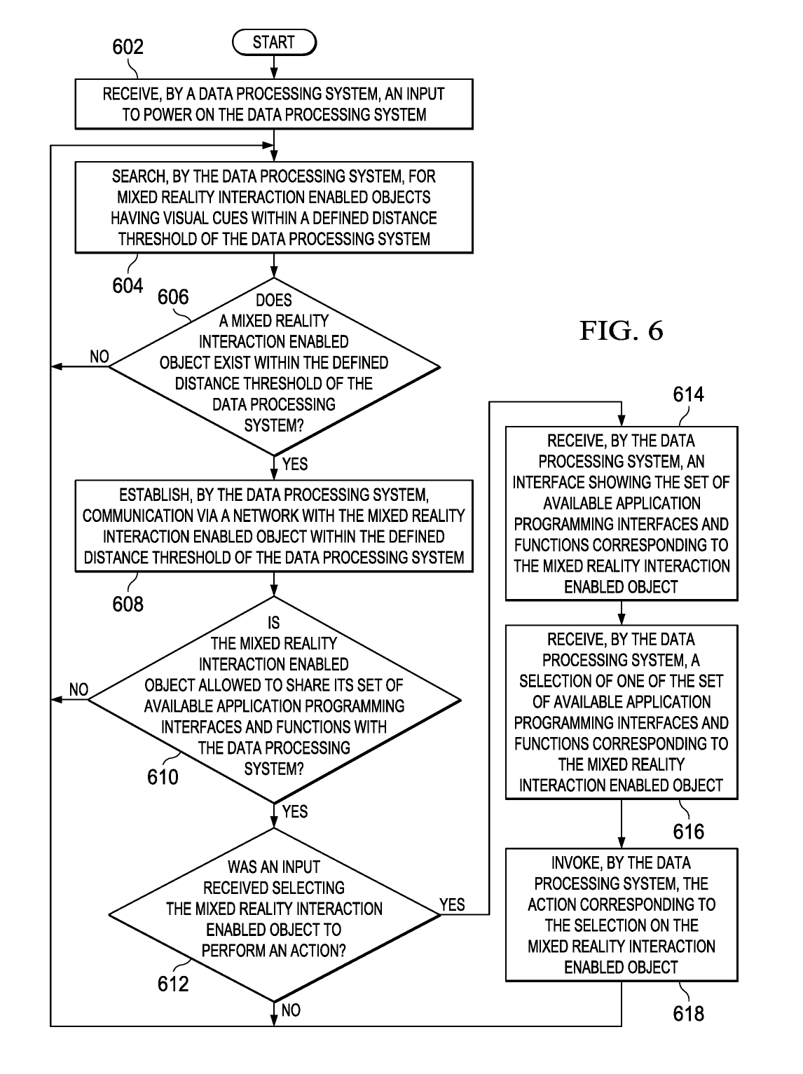

With reference now to FIG. 5, an example of multiple mixed reality interaction enabled objects with a set of shared available functions is depicted in accordance with an illustrative embodiment. Multiple mixed reality interaction enabled objects with a set of shared available functions 500 represents a plurality of mixed reality interaction enabled objects that have a common set of available functions for selection by a user of a mixed reality interface device. The user of the mixed reality interface device may be, for example, mixed reality user 306 utilizing mixed reality interface device 302 in FIG. 3 or user 406 utilizing mixed reality interface device 404 in FIG. 4.

In this example, multiple mixed reality interaction enabled objects with a set of shared available functions 500 includes mixed reality interaction enabled object 502, mixed reality interaction enabled object 504, and mixed reality interaction enabled object 506. Also in this example, mixed reality interaction enabled object 502 is a landline telephone, mixed reality interaction enabled object 504 is a television set, and mixed reality interaction enabled object 506 is remote speakers. Further in this example, mixed reality interaction enabled object 502, mixed reality interaction enabled object 504, and mixed reality interaction enabled object 506 include common set of functions interface 508, 510, and 512, respectively. The common set of functions in each interface is “Power On”, “Power Off”, and “Mute”. The user of the mixed reality interface device may select one of the functions, such as “Mute”, in the common set of functions to have that particular “Mute” function invoked on each of mixed reality interaction enabled objects 502, 504, and 506.

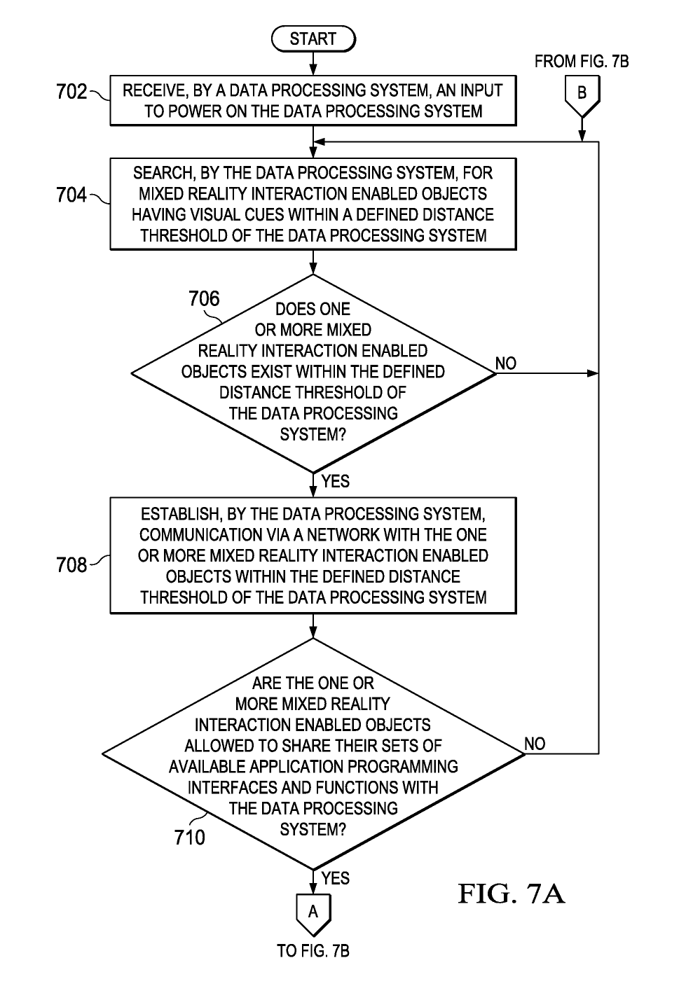

With reference now to FIG. 6, a flowchart illustrating a process for invoking a function corresponding to a mixed reality object is shown in accordance with an illustrative embodiment. The process shown in FIG. 6 may be implemented in a data processing system, such as, for example, client 110 in FIG. 1, data processing system 200 in FIG. 2, mixed reality interface device 302 in FIG. 3, or mixed reality interface device 404 in FIG. 4.

The process begins when the data processing system receives an input to power on the data processing system (step 602). Afterward, the data processing system searches for mixed reality interaction enabled objects having visual cues, such as, for example, mixed reality interaction enabled object 402 having visual cue 408 in FIG. 4, within a defined distance threshold of the data processing system (step 604). The defined distance threshold may be, for example, distance threshold 222 in FIG. 2.

Then, the data processing system makes a determination as to whether a mixed reality interaction enabled object exists within the defined distance threshold of the data processing system (step 606). If the data processing system determines that no mixed reality interaction enabled object exists within the defined distance threshold of the data processing system, no output of step 606, then the process returns to step 604 where the data processing system continues to search for mixed reality interaction enabled objects having visual cues. If the data processing system determines that a mixed reality interaction enabled object exists within the defined distance threshold of the data processing system, yes output of step 606, then the data processing system establishes communication via a network with the mixed reality interaction enabled object within the defined distance threshold of the data processing system (step 608). The network may be, for example, network 102 in FIG. 1.

In addition, the data processing system makes a determination as to whether the mixed reality interaction enabled object is allowed to share its set of available application programming interfaces and functions with the data processing system (step 610). If the data processing system determines that the mixed reality interaction enabled object is not allowed to share its set of available application programming interfaces and functions with the data processing system, no output of step 610, then the process returns to step 604 where the data processing system continues to search for mixed reality interaction enabled objects having visual cues. If the data processing system determines that the mixed reality interaction enabled object is allowed to share its set of available application programming interfaces and functions with the data processing system, yes output of step 610, then the data processing system makes a determination as to whether an input was received selecting the mixed reality interaction enabled object to perform an action (step 612).

If the data processing system determines that no input was received selecting the mixed reality interaction enabled object to perform an action, no output of step 612, then the process returns to step 604 where the data processing system continues to search for mixed reality interaction enabled objects having visual cues. If the data processing system determines that an input was received selecting the mixed reality interaction enabled object to perform an action, yes output of step 612, then the data processing system receives an interface showing the set of available application programming interfaces and functions corresponding to the mixed reality interaction enabled object (step 614). The interface may be, for example, function interface 410 in FIG. 4.

Subsequently, the data processing system receives a selection of one of the set of available application programming interfaces and functions corresponding to the mixed reality interaction enabled object (step 616). Afterward, the data processing system invokes the action corresponding to the selection on the mixed reality interaction enabled object (step 618). Thereafter, the process returns to step 604 where the data processing system continues to search for mixed reality interaction enabled objects having visual cues.

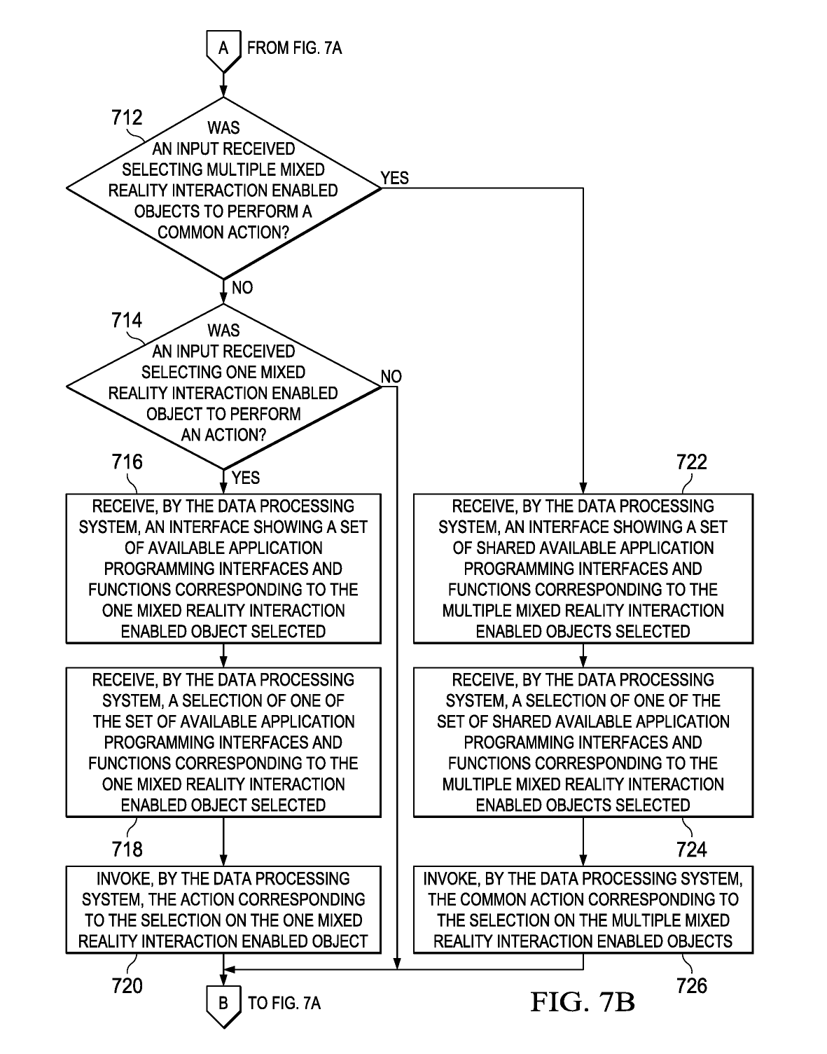

With reference now to FIGS. 7A-7B, a flowchart illustrating a process for invoking a common function corresponding to multiple mixed reality objects is shown in accordance with an illustrative embodiment. The process shown in FIGS. 7A-7B may be implemented in a data processing system, such as, for example, client 110 in FIG. 1, data processing system 200 in FIG. 2, mixed reality interface device 302 in FIG. 3, or mixed reality interface device 404 in FIG. 4.

The process begins when the data processing system receives an input to power on the data processing system (step 702). Afterward, the data processing system searches for mixed reality interaction enabled objects having visual cues, such as, for example, mixed reality interaction enabled object 402 having visual cue 408 in FIG. 4, within a defined distance threshold of the data processing system (step 704). The defined distance threshold may be, for example, distance threshold 222 in FIG. 2.

Then, the data processing system makes a determination as to whether one or more mixed reality interaction enabled objects exist within the defined distance threshold of the data processing system (step 706). If the data processing system determines that no mixed reality interaction enabled object exists within the defined distance threshold of the data processing system, no output of step 706, then the process returns to step 704 where the data processing system continues to search for mixed reality interaction enabled objects having visual cues. If the data processing system determines that one or more mixed reality interaction enabled objects exist within the defined distance threshold of the data processing system, yes output of step 706, then the data processing system establishes communication via a network with the one or more mixed reality interaction enabled objects within the defined distance threshold of the data processing system (step 708). The network may be, for example, network 102 in FIG. 1.

In addition, the data processing system makes a determination as to whether the one or more mixed reality interaction enabled objects are allowed to share their sets of available application programming interfaces and functions with the data processing system (step 710). If the data processing system determines that the one or more mixed reality interaction enabled objects are not allowed to share their sets of available application programming interfaces and functions with the data processing system, no output of step 710, then the process returns to step 704 where the data processing system continues to search for mixed reality interaction enabled objects having visual cues. If the data processing system determines that the one or more mixed reality interaction enabled objects are allowed to share their sets of available application programming interfaces and functions with the data processing system, yes output of step 710, then the data processing system makes a determination as to whether an input was received selecting multiple mixed reality interaction enabled objects to perform a common action (step 712).

If the data processing system determines that no input was received selecting multiple mixed reality interaction enabled objects to perform a common action, no output of step 712, then the data processing system makes a determination as to whether an input was received selecting one mixed reality interaction enabled object to perform an action (step 714). If the data processing system determines that no input was received selecting one mixed reality interaction enabled object to perform an action, no output of step 714, then the process returns to step 704 where the data processing system continues to search for mixed reality interaction enabled objects having visual cues. If the data processing system determines that an input was received selecting one mixed reality interaction enabled object to perform an action, yes output of step 714, then the data processing system receives an interface showing a set of available application programming interfaces and functions corresponding to the one mixed reality interaction enabled object selected (step 716). The interface may be, for example, function interface 410 in FIG. 4.

Subsequently, the data processing system receives a selection of one of the set of available application programming interfaces and functions corresponding to the one mixed reality interaction enabled object selected (step 718). Afterward, the data processing system invokes the action corresponding to the selection on the one mixed reality interaction enabled object (step 720). Thereafter, the process returns to step 704 where the data processing system continues to search for mixed reality interaction enabled objects having visual cues.

Returning again to step 712, if the data processing system determines that an input was received selecting multiple mixed reality interaction enabled objects to perform a common action, yes output of step 712, then the data processing system receives an interface showing a set of shared available application programming interfaces and functions corresponding to the multiple mixed reality interaction enabled objects selected (step 722). Subsequently, the data processing system receives a selection of one of the set of shared available application programming interfaces and functions corresponding to the multiple mixed reality interaction enabled objects selected (step 724). Afterward, the data processing system invokes the common action corresponding to the selection on the multiple mixed reality interaction enabled objects (step 726). Thereafter, the process returns to step 704 where the data processing system continues to search for mixed reality interaction enabled objects having visual cues.

Thus, illustrative embodiments of the present invention provide a computer implemented method, data processing system, and computer program product for generating an interface in a mixed reality environment that exposes functionality of an object in the mixed reality environment and invoking a function of the object via the interface. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-20. (canceled)

21. A computer-implemented method of invoking a function of a mixed reality interaction enabled object on a computing system, the computer-implemented method comprising:
determining by the computing system whether there is one or more mixed reality interaction enabled objects at a location;
in response to determining that there is one or more mixed reality interaction enabled objects at the location, enabling a user to select at least one of the one or more mixed reality interaction enabled objects with which to interact;
selecting, by the user, at least one of the one or more mixed reality interaction enabled objects with which to interact
obtaining, in response to the user selecting the at least one of the one or more mixed reality interaction enabled objects with which to interact, from the selected at least one of the one or more mixed reality interaction enabled objects, one or more application programming interfaces, the one or more application programming interfaces providing one or more functions that may be invoked by the user;
displaying on a display system associated with the computing system the one or more application programming interfaces to the user; and
invoking, upon the user selecting at least one of the one or more provided functions, the at least one selected function.

22. The computer-implemented method of claim 21, wherein enabling a user to select at least one of the one or more mixed reality interaction enabled objects with which to interact includes enabling the user to use an imaging device associated with the computing system with which to focus on the one or more mixed reality interaction enabled objects.

23. The computer-implemented method of claim 21, wherein obtaining from the selected at least one of the one or more mixed reality interaction enabled objects one or more application programming interfaces further includes obtaining an identifier and an authorization access from the selected at least one of the one or more mixed reality interaction enabled objects, the identifier for uniquely identifying the selected at least one or more mixed reality interaction enabled objects and the access authorization for determining whether the user is authorized to interact with the selected at least one or more mixed reality interaction enabled objects.

24. The computer-implemented method of claim 21, further comprising:
obtaining, in response to the user selecting two or more mixed reality interaction enabled objects with which to interact, one or more application programming interfaces from each one of the two or more selected mixed reality interaction enabled objects;
determining, using the obtained one or more application programming interfaces from each one of the two or more selected mixed reality interaction enabled objects, whether one of the two or more selected mixed reality interaction enabled objects has a function in common with at least another one of the two or more selected mixed reality interaction enabled objects;
displaying one application programming interface to the user displaying the common function; and
invoking, upon the user selecting the common function, the common function on the two or more selected mixed reality interaction enabled objects having the common function.

25. The computer-implemented method of claim 21, wherein the user transmits to users remote to the location the determined one or more mixed reality interaction enabled objects such that the remote users may interact with the determined one or more mixed reality interaction enabled objects.

26. The computer-implemented method of claim 21, wherein determining whether there is one or more mixed reality interaction enabled objects at the location includes the determined one or more mixed reality interaction enabled objects providing a cue to the user, the cue informing the user that the determined one or more mixed reality interaction enabled objects are mixed reality objects.

27. The computer-implemented method of claim 26, wherein the cue includes visual marks that can be read by the computing device.

28. The computer-implemented method of claim 27, wherein the cue includes one of radio frequency identification tags, bar codes, quick response codes.

29. The computer-implemented method of claim 21, further comprising:
allowing the user to add an information field to the determined one or more mixed reality interaction enabled objects in order to add information.

30. The computer-implemented method of claim 29, the information includes a tag, the tag for assigning ownership of the determined one or more mixed reality interaction enabled objects to a person, or to provide an expiration date in cases where the determined one or more mixed reality interaction enabled objects are food objects.

31. The computer-implemented method of claim 21, wherein the one or more application programming interfaces include an application programming interface of a third party, the application programming interface of the third party allowing interactions with the third party corresponding to the determined one or more mixed reality interaction enabled objects.

32. A computing system for invoking a function of a mixed reality interaction enabled object, the computing comprising:
at least one storage device for storing program code; and
at least one processor for processing the program code to:
determine whether there is one or more mixed reality interaction enabled objects at a location;
in response to determining that there is one or more mixed reality interaction enabled objects at the location, enable a user to select at least one of the one or more mixed reality interaction enabled objects with which to interact;
in response to the user selecting at least one of the one or more mixed reality interaction enabled objects with which to interact, obtain from the selected at least one of the one or more mixed reality interaction enabled objects, one or more application programming interfaces, the one or more application programming interfaces providing one or more functions that may be invoked by the user;
display on a display system associated with the computing system the one or more application programming interfaces to the user; and
invoke, upon the user selecting at least one of the one or more provided functions, the at least one selected function.

33. The computing system of claim 32, wherein the program code is further processed to:
obtain, in response to the user selecting two or more mixed reality interaction enabled objects with which to interact, one or more application programming interfaces from each one of the two or more selected mixed reality interaction enabled objects;
determine, using the obtained one or more application programming interfaces from each one of the two or more selected mixed reality interaction enabled objects, whether one of the two or more selected mixed reality interaction enabled objects has a function in common with at least another one of the two or more selected mixed reality interaction enabled objects;
display one application programming interface to the user displaying the common function; and
invoke, upon the user selecting the common function, the common function on the two or more selected mixed reality interaction enabled objects having the common function.

34. The computing system of claim 32, wherein the user transmits to users remote to the location the determined one or more mixed reality interaction enabled objects such that the remote users may interact with the determined one or more mixed reality interaction enabled objects.

35. The computing system of claim 32, wherein the program code is further processed to:
allow the user to add an information field to the determined one or more mixed reality interaction enabled objects in order to add information, the information including assigning ownership of the determined one or more mixed reality interaction enabled objects to a person, or providing an expiration date in cases where the determined one or more mixed reality interaction enabled objects are food objects.

36. A computer program product for invoking a function of a mixed reality interaction enabled object on a computing system, the computer program product comprising:
a computer readable storage medium having computer readable program code embodied therewith for execution on the computing system, the computer readable program code comprising computer readable program code configured to:
determine whether there is one or more mixed reality interaction enabled objects at a location;
in response to determining that there is one or more mixed reality interaction enabled objects at the location, enable a user to select at least one of the one or more mixed reality interaction enabled objects with which to interact;
in response to the user selecting at least one of the one or more mixed reality interaction enabled objects with which to interact, obtain from the selected at least one of the one or more mixed reality interaction enabled objects, one or more application programming interfaces, the one or more application programming interfaces providing one or more functions that may be invoked by the user;
display on a display system associated with the computing system the one or more application programming interfaces to the user; and
invoke, upon the user selecting at least one of the one or more provided functions, the at least one selected function.

37. The computer program product of claim 36, wherein obtaining from the selected at least one of the one or more mixed reality interaction enabled objects one or more application programming interfaces further includes obtaining an identifier and an access authorization from the selected at least one of the one or more mixed reality interaction enabled objects, the identifier for uniquely identifying the selected at least one or more mixed reality interaction enabled objects and the access authorization for determining whether the user is authorized to interact with the selected at least one or more mixed reality interaction enabled objects.

38. The computer program product of claim 36, further comprising computer readable program code configured to:
obtain, in response to the user selecting two or more mixed reality interaction enabled objects with which to interact, one or more application programming interfaces from each one of the two or more selected mixed reality interaction enabled objects;
determine, using the obtained one or more application programming interfaces from each one of the two or more selected mixed reality interaction enabled objects, whether one of the two or more selected mixed reality interaction enabled objects has a function in common with at least another one of the two or more selected mixed reality interaction enabled objects;
display one application programming interface to the user displaying the common function; and
invoke, upon the user selecting the common function, the common function on the two or more selected mixed reality interaction enabled objects having the common function.

39. The computer program product of claim 36, wherein the user transmits to users remote to the location the determined one or more mixed reality interaction enabled objects such that the remote users may interact with the determined one or more mixed reality interaction enabled objects.

40. The computer program product of claim 36, further comprising computer readable program code configured to:
allow the user to add an information field to the determined one or more mixed reality interaction enabled objects in order to add information.
